(19) United States
(12) Patent Application Publication
(10) Pub. No.: US 2010/0088897 A1
(43) Pub. Date: Apr. 15, 2010

(54) FINISHING PROCESS FOR BEARING COMPONENTS

(75) Inventor: Alex Habibvand, Orange, CA (US)

Correspondence Address: MICHAUD-Kinney Group LLP, 306 INDUSTRIAL PARK ROAD, SUITE 206, MIDDLETOWN, CT, 06457, US

(73) Assignee: ROLLER BEARING COMPANY OF AMERICA, INC., OXFORD, CT (US)

(21) Appl. No.: 12/576,367

(22) Filed: Oct. 9, 2009

Related U.S. Application Data
(60) Provisional application No. 61/104,000, filed on Oct. 9, 2008.

(51) Int. Cl. F16C 33/64; B24B 31/14

(52) U.S. Cl. 29/898.13; 451/49; 451/326; 384/625

(57) ABSTRACT

A method for treating bearing components includes treating the bearing components in a tumbling-type cutting surface treatment; treating the bearing components in a tumbling-type burnishing treatment; and treating the bearing components in a tumbling-type cleaning and polishing treatment, to provide finished components.

### CROSS REFERENCE TO RELATED APPLICATIONS

This application claims the benefit of U.S. Provisional Patent Application Ser. No. 61/104,000, filed Oct. 9, 2008, which is incorporated herein by reference in its entirety.

### FIELD OF THE INVENTION

This invention relates to the manufacture of bearing components, and in particular to surface finishing of bearing components.

### BACKGROUND

Rolling element bearings are widely used in mechanical systems. In general, during use bearings are subject to repeated dynamic rolling contact and sliding contact stresses. However, the desire is that such bearings operate smoothly and with acceptable vibration under such conditions. Slight imperfections in features of a bearing might lead to premature wear and failure as well as excessive vibration and, consequently, downtime of the mechanical system incorporating the bearing. The level of surface finish on a bearing rolling element is typically controlled. In many instances, the better the surface finish, the smoother the bearing will run. In addition, the level of surface finish can affect the speed at which a bearing can run. In addition to the rolling element, the surfaces of components such as the inner and outer races upon which the rolling elements roll also are usually manufactured using tight tolerances and high levels of surface finish. For example, in order to minimize stresses and improve bearing performance, corners in areas where the bearing components are subjected to stress are often blended to minimize any stress to concentrations as well as to improve upon the smoothness of bearing operation.

### SUMMARY OF THE INVENTION

The present invention resides in one aspect in a method for treating bearing components. The method includes treating the bearing components in a tumbling-type cutting surface treatment; treating the bearing components in a tumbling-type burnishing treatment; drying the components; and treating the bearing components in a tumbling-type cleaning and polishing treatment to provide finished components.

The present invention resides in another aspect in a bearing that includes one or more components that are treated as described herein.

### BRIEF DESCRIPTION OF THE DRAWINGS

FIG. 1 is a schematic process flow chart depicting a finishing treatment according to one embodiment of the present invention.

### DETAILED DESCRIPTION OF THE INVENTION

Bearing components are treated by a process described herein to achieve a fine surface finish and blended functional corners. It is conceivable using the process described herein, that surface finishes better than 3 AA (3 microinches, per arithmetic average) can be achieved. Tests of bearing rollers that have been treated using the process described herein show superior performance in comparison to rollers that are not treated. The bearing components that may be treated as described herein include, but are not limited to, rollers, rings, cages, etc., that are made from metal (steel, aluminum, aluminum alloy, titanium, titanium alloy, etc).

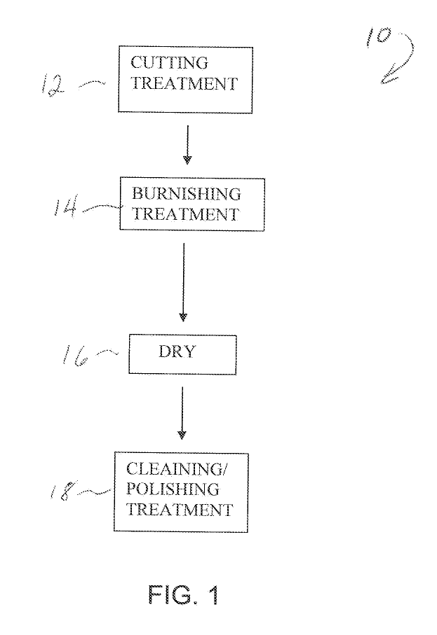

A method for providing finished bearing components includes treating the bearing components in a tumbling-type cutting surface treatment; a tumbling-type burnishing treatment; and a tumbling-type cleaning and polishing treatment. As shown in FIG. 1, one embodiment of the process of the present invention, indicated generally by the numeral “10,” includes a cutting treatment 12, a burnishing treatment 14, drying 16, and a cleaning/polishing treatment 18. The cutting treatment 12, burnishing treatment 14 and the cleaning/polishing treatment 18 are tumbling-type processes in which the components are disposed in a container with surface treatment media, and the container is rotated to cause the surface treatment media to impinge on the surfaces of the components.

For the cutting treatment 12, a bearing component is loaded with cutting media into a barrel of a centrifugal barrel finishing machine. The cutting media for the cutting treatment may comprise one or both of carbide (e.g., silicon carbide such as black silicon carbide, green silicon carbide, boron carbide and the like) or oxide (e.g., alumina, silica, and the like) triangular cutting media, although the invention is not limited in this regard, and in other embodiments, other cutting media may be used. One or more additives such as rust inhibitors and/or detergents may also be added, if desired.

A suitable centrifugal barrel finishing machine comprises a plurality of barrels that are rotatably mounted on a turret. The barrels have interior compartments in which the bearing components, cutting media, and optional additives can be placed. The turret, and thereby the barrels, rotate around a shaft. The barrels are rotatably mounted on the turret so that they can also rotate as they orbit about the shaft. The rotation and orbiting motion of the barrels cause the cutting media (or other finishing media, in other process steps) to contact and smooth the surfaces of the components in the barrel. Preferably, the barrels mounted on the machine are loaded to be of approximately equal weight for balanced rotation during operation. The centrifugal barrel finishing machine is operated to generate centrifugal force to effect a cutting treatment on the components, for the removal of burrs and other larger surface defects from the components. Subsequent to the cutting treatment, the components and cutting media are removed from the barrels and are separated from one another and rinsed.

For the burnishing treatment 14, the components are placed in a barrel of the centrifugal barrel finishing machine with a burnishing media and, optionally, with rust inhibitors and detergents. The centrifugal barrel finishing machine is operated to attain an intermediary surface finish treatment on the components. The burnishing media may be a carbide (e.g., silicon carbide such as black silicon carbide, green silicon carbide, boron carbide and the like) or oxide (e.g., alumina, silica, and the like) fine burnishing media. However, the process described herein is not limited in this regard, and in other embodiments other burnishing media may be used. Following the burnishing treatment, the components and burnishing media are removed from the barrels, and are separated. The barrels are then rinsed. The components are then dried (step 16). A machine such as a centrifugal force dryer can be used to accomplish the drying step.

The dried components are then cleaned and/or polished (step 18) by being mixed with a finishing media such as corn cob grit. However, the present invention is not limited in this regard as other finishing media that are suitable for treating metal parts are known, e.g., walnut shells and the like. The mixer is operated until the components are dry and a desired surface finish treatment is obtained.

The process of this invention is especially useful for the manufacture of components for bearings for use in critical high speed applications.

Finished components may be dipped in preservative oil, and may then be packaged for storage.

As indicated above, the process described herein can be employed to provide a fine surface finish and highly blended functional corners in bearing components. In one particular aspect, the treatment described herein provides a unique configuration to the corners of rollers for bearings. Tests of bearing rollers that have been treated as described herein show that the treated rollers exhibit superior performance in comparison to rollers that are not treated as described herein. Without wishing to be bound by any particular theory, it is believed that with highly smooth and super-blended corners resulting from a treatment as described herein, churning and cutting of lubrication film during rotational interaction between moving corners of bearing components are greatly minimized or completely eliminated. In tribological terms, in bearings that include components treated as described herein, an elasto-hydro-dynamic (EHD) lubrication film is maintained on all working surfaces at all times. In contrast, when corners are poorly blended the EHD film is violated and the so-called “boundary lubrication” condition prevails. With fully developed and sustained EHD lubrication film, bearings operate cooler and longer free of any incipient wear. Similar in effect to a very fine shot-peening process, the process described herein can also induce residual compressive stresses on bearing surfaces, which are beneficial to bearing fatigue life. While the specific advantages of treating bearing rollers are described, the invention is not limited in this regard, and other bearing components may be treated as described herein as well, including rings, cages, etc.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for treating rolling bearing components, comprising:
treating the bearing components in a tumbling-type cutting surface treatment;
treating the bearing components in a tumbling-type burnishing treatment; and
treating the bearing components in a tumbling-type cleaning and polishing treatment to provide finished components.

2. The method of claim 1, wherein the tumbling-type cutting surface treatment comprises placing the bearing components and a cutting media in barrels on a centrifugal barrel finishing machine, and operating the centrifugal barrel finishing machine to achieve a preliminary surface finish;
wherein the tumbling-type burnishing treatment comprises placing the bearing components and burnishing media in barrels on a centrifugal barrel finishing machine and operating the centrifugal barrel finishing machine for a time sufficient to achieve an intermediate surface finish; and
wherein the tumbling-type cleaning and polishing treatment comprises tumbling the components with a finishing medium in a mixer.

3. The process of claim 1, wherein the cutting media comprises carbide or oxide triangular cutting media, or both.

4. The process of claim 1, wherein the cutting media comprises silicon carbide or alumina triangular cutting media, or both.

5. The process of claim 1, wherein burnishing media comprises carbide or oxide fine burnishing media, or both.

6. The process of claim 1, wherein the burnishing media comprises silicon carbide or alumina fine burnishing media, or both.

7. The process of claim 1, wherein the cutting media comprises carbide or oxide triangular cutting media, or both; and
wherein the burnishing media comprises carbide or oxide fine burnishing media, or both.

8. The process of claim 1, wherein the cutting media comprises silicon carbide or aluminum oxide triangular cutting media, or both; and
wherein the burnishing media comprises silicon carbide or alumina fine burnishing media, or both.

9. The process of claim 1, wherein the bearing components comprise one or more of rollers, races and cages.

10. The process of claim 2, wherein the bearing components comprise one or more of rollers, races and cages.

11. The process of claim 1, further comprising drying the components after the tumbling-type burnishing treatment.

12. The process of claim 1, wherein the finishing media comprises corn cob grit.

13. A rolling bearing comprising one or more components treated by the method of claim 1.
